(19) United States
(12) Patent Application Publication
(10) Pub. No.: US 2012/0273140 A1
(43) Pub. Date: Nov. 1, 2012

(54) APPARATUS, SYSTEM, AND METHOD FOR COVERING A WINDOW

(76) Inventor: Ruben N. Morales, Salt Lake City, UT (US)

(21) Appl. No.: 13/458,799

(22) Filed: Apr. 27, 2012

Related U.S. Application Data
(63) Continuation-in-part of application No. 13/330,256, filed on Dec. 19, 2011.
(60) Provisional application No. 61/479,725, filed on Apr. 27, 2011.

(51) Int. Cl. E06B 9/78; E06B 9/44

(52) U.S. Cl. 160/120; 160/323.1; 160/309; 160/127

(57) ABSTRACT

The apparatus for covering a window includes a first support member and a second support member spaced apart from the first support member and substantially parallel to the first support member. The apparatus also includes a fabric extending between the first support member and the second support member. The fabric is movably coupled to the first support member and the second support member. The fabric forms a continuous loop through which the first support member and the second support member extend.

### CROSS-REFERENCE TO RELATED APPLICATION

This application claims the benefit of U.S. Provisional Patent Application No. 61/479,725 entitled “APPARATUS, SYSTEM, AND METHOD FOR COVERING A WINDOW” and filed on Apr. 27, 2011 for Ruben N. Morales which is incorporated herein by reference. In addition, this application claims the benefit of U.S. patent application Ser. No. 13/330,256 entitled “APPARATUS, SYSTEM, AND METHOD FOR COVERING A WINDOW” and filed on Dec. 19, 2011 for Ruben N. Morales which is incorporated herein by reference.

### FIELD

The present disclosure relates to window coverings and more particularly relates to window coverings having an elastic fabric movably coupled to support members.

### BACKGROUND

Window coverings, including blinds, drapes, and curtains, are typically used to provide privacy and shielding from the sun. Often, window blinds are made of multiple slats of plastic, wood, or metal, rotatable to open or close. Window blinds invariably collect dust and dirt and due to the number of slats—each with two surfaces—in a typical window blind, window blinds can be cumbersome to clean. Furthermore, drapes and curtains also collect dust and dirt. These window coverings often require removal from a window for cleaning and removing may involve unfastening a rod, often requiring undoing screws or bolts and often at significant heights near the ceiling accessible only by a ladder or stepstool, and unthreading the drape or curtain.

### SUMMARY

From the foregoing discussion, it should be apparent that a need exists for an apparatus, system, and method for covering a window. Beneficially, such an apparatus, system, and method would be readily installable and convenient to remove and reattach.

The present disclosure has been developed in response to the present state of the art, and in particular, in response to the problems and needs in the art that have not yet been fully solved by currently available window coverings. Accordingly, the present subject matter has been developed to provide an apparatus, system, and method for covering a window that overcome many or all of the above-discussed shortcomings in the art.

One embodiment of an apparatus includes a first support member and a second support member spaced apart from the first support member and substantially parallel to the first support member. The embodiment also includes a fabric extending between the first support member and the second support member. The fabric is movably coupled to the first support member and the second support member. The fabric forms a continuous loop through which the first support member and the second support member extend.

In certain implementations, the apparatus includes a first anchored bracket configured to receive and prevent movement of the first support member in a first direction towards the second support member and a second anchored bracket configured to receive and prevent movement of the second support member in a second direction towards the first support member. In some implementations the first support member and/or the second support member are secured against the first anchored bracket and the second anchored bracket, respectively, by tension in the fabric.

In some implementations, the apparatus includes a third support member positioned substantially parallel to the first support member and a fourth support member positioned substantially parallel to the second support member. In certain further implementations, the third support member is spaced apart from the first support member and the fourth support member is spaced apart from the second support member. In some further implementations, the third support member is coupled to a first end of the first support member and releasably coupled to a second end of the first support member and the fourth support member is coupled to a first end of the second support member and releasably coupled to a second end of the second support member.

In some implementations, the first support member defines a first interior space within the first support member and the third support member lies within the first interior space Likewise, in some implementations, the second support member defines a second interior space within the second support member and the fourth support member lies within the second interior space.

In certain implementations, the fabric is a first fabric and the apparatus further includes a second fabric extending between the third support member and the fourth support member. The second fabric can be movably coupled to the third support member and the fourth support member.

In some implementations, the continuous loop is a first continuous loop and the second fabric forms a second continuous loop through which the third support member and the fourth support member extend. The second continuous loop can be within the first continuous loop. In certain implementations, the apparatus includes a third anchored bracket coupled to the first support member. The third anchored bracket can be configured to receive and prevent movement of the third support member in the first direction towards the fourth support member. In these implementations, the apparatus also includes a fourth anchored bracket coupled to the second support member. The fourth anchored bracket can be configured to receive and prevent movement of the fourth support member in the second direction towards the third support member.

In some implementations, the first support member includes a first elongate element and a first sleeve movably coupled to the first elongate element. In some implementations, the second support member includes a second elongate element and a second sleeve movably coupled to the second elongate element. The fabric can be wrapped around the first sleeve and the second sleeve and the first sleeve and the second sleeve can be slidable along the first elongate element and the second elongate elements respectively.

In certain implementations, the first support member defines an interior space and the apparatus further includes a driving mechanism coupled to the first support member. In certain further implementations, the apparatus also includes a threaded rod rotatably driven by the driving mechanism. The threaded rod can be positioned within the interior space of the first support member. In some further implementations, the apparatus includes a carrier threadably engaged with the threaded rod. The carrier can be linearly movable along an interior of the first support member via rotation of the threaded rod. In certain implementations, the apparatus includes a fabric engaging element that extends from the interior of the first support member through a slot in the first support member. The fabric engaging element can prevent the carrier from co-rotating with the threaded rod. The fabric engaging element can be operable to slide the fabric along the first support member and the second support member in response to the driving mechanism driving the threaded rod.

In certain implementations, the apparatus includes a first insulating member positioned about the fabric in contact with the first support member adjoining a first end of the fabric. The first end can be adjacent to the first support member along a length of the first support member. In some further implementations, the apparatus includes a second insulating member adjoining a second end of the fabric. The second end can be adjacent to the second support member along a length of the second support member.

In some implementations, the first support member, the second support member, and the first fabric are a first fabric assembly and the apparatus further includes a second fabric assembly pivotably coupled to the first fabric assembly.

An embodiment of window covering includes a first elongated support member including a first telescoping pole. The window covering includes a second elongated support member spaced apart from the first elongated support member and substantially parallel to the first elongated support member. The second elongated support member includes a second telescoping pole. The window covering also includes an elastic fabric extending between the first elongated support member and the second elongated support member. The fabric is movably coupled to the first elongated support member and the second elongated support member. The fabric forms a continuous loop extending around the first elongated support member and the second elongated support member.

In some implementations, the window covering further includes a first anchored bracket configured to receive and prevent movement of the first elongated support member in a first direction towards the second elongated support member. In some further implementations, the window covering includes a second anchored bracket configured to receive and prevent movement of the second elongated support member in a second direction towards the first elongated support member.

In some implementations, the first elongated support member and/or the second elongated support member are secured against the first anchored bracket and the second anchored bracket, respectively, by tension in the fabric. In certain embodiments, a third elongated support member is spaced apart from the first elongated support member and substantially parallel to the first elongated support member and a fourth elongated support member spaced is apart from the second elongated support member and substantially parallel to the second elongated support member.

In certain implementations, the fabric is a first fabric and the window covering further includes a second fabric extending between the third elongated support member and the fourth elongated support member. The fabric can be movably coupled to the third elongated support member and the fourth elongated support member.

One embodiment of a method includes providing a window covering including a first support member and a second support member spaced apart from the first support member and substantially parallel to the first support member. The window covering also includes a fabric extending between the first support member and the second support member. The fabric is movably coupled to the first support member and the second support member. The fabric forms a continuous loop through which the first support member and the second support member extend. The method includes sliding the fabric along the first support member and the second support member.

Another embodiment of an apparatus includes a first vertical pole and a second vertical pole parallel to the first vertical pole and spaced apart from the first vertical pole. The apparatus also includes a loop of fabric tightly fit about the first vertical pole and the second vertical pole and frictional engagement between the loop of fabric and the first vertical pole and the second vertical pole maintains a vertical position of the loop of fabric relative to the poles.

In one implementation of the present subject matter, a window covering includes a first elongation support member, a second elongated support member, and an elastic fabric extending between the first elongated support member and the second elongated support member. In such an embodiment, the first elongated support member and the second elongated support member are positioned substantially parallel to one another. The elastic fabric extends between the first elongated support member and the second elongated support member and is movably coupled to the first elongated support member and the second elongated support member.

Reference throughout this specification to features, advantages, or similar language does not imply that all of the features and advantages that may be realized with the present subject matter should be or are in any single embodiment of the subject matter. Rather, language referring to the features and advantages is understood to mean that a specific feature, advantage, or characteristic described in connection with an embodiment is included in at least one embodiment of the present subject matter. Thus, discussion of the features and advantages, and similar language, throughout this specification may, but do not necessarily, refer to the same embodiment.

Furthermore, the described features, advantages, and characteristics of the subject matter may be combined in any suitable manner in one or more embodiments. One skilled in the relevant art will recognize that embodiments of the subject matter may be practiced without one or more of the specific features or advantages of a particular embodiment. In other instances, additional features and advantages may be recognized in certain embodiments that may not be present in all embodiments of the subject matter. These features and advantages of the present subject matter will become more fully apparent from the following description and appended claims, or may be learned by the practice of the subject matter as set forth hereinafter.

### BRIEF DESCRIPTION OF THE DRAWINGS

In order that the advantages of the present subject matter will be readily understood, a description of the present subject matter will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1A is a perspective view illustrating one embodiment of a window covering apparatus in accordance with the present subject matter;

FIG. 1B is a front view illustrating one embodiment of a first support member and a second support member of the apparatus of FIG. 1A in accordance with the present subject matter;

FIG. 2 is a front view further illustrating the first support member and the second support member of FIG. 1B with extended fabric in accordance with the present subject matter;

FIG. 3 is a top view illustrating the apparatus of FIG. 1A in accordance with the present subject matter;

FIG. 4A is a front view further illustrating the apparatus of FIG. 1A in accordance with the present subject matter;

FIG. 4B is a front view further illustrating the apparatus of FIG. 1A in accordance with the present subject matter;

FIG. 5A is a perspective view illustrating one embodiment of an anchored bracket in accordance with the present subject matter;

FIG. 5B is a top view further illustrating the anchored bracket of FIG. 5A in accordance with the present subject matter;

FIG. 6A is a perspective view further illustrating the anchored bracket of FIG. 5A in accordance with the present subject matter;

FIG. 6B is a top view further illustrating the anchored bracket of FIG. 5A in accordance with the present subject matter;

FIG. 7 is a front view illustrating another embodiment of a window covering apparatus in accordance with the present subject matter;

FIG. 8 is a front view further illustrating the apparatus of FIG. 7 with extended fabric in accordance with the present subject matter;

FIG. 9 is a top view illustrating the apparatus of FIG. 7 in accordance with the present subject matter;

FIG. 10 is a perspective view illustrating yet another embodiment of a window covering apparatus in accordance with the present subject matter;

FIG. 11A is a top view illustrating a support member in accordance with the present subject matter;

FIG. 11B is a top view illustrating the support member of FIG. 11A with an additional support member in accordance with the present subject matter;

FIG. 12 is a perspective view illustrating the support member of FIG. 11 in accordance with the present subject matter;

FIG. 13 is a top view illustrating window covering apparatus of FIG. 10 in accordance with the present subject matter;

FIG. 14 is a front view of a further embodiment of a window covering apparatus in accordance with the present subject matter;

FIG. 15A is a perspective view illustrating another embodiment of an anchored bracket in accordance with the present subject matter;

FIG. 15B is a top view further illustrating the anchored bracket of FIG. 14A in accordance with the present subject matter;

FIG. 15C is a top view further illustrating the anchored bracket of FIG. 14A releasably engaged with a support member in accordance with the present subject matter;

FIG. 16 is a front view illustrating one embodiment of a divider apparatus in accordance with the present subject matter;

FIG. 17 is a front view illustrating another embodiment of a divider apparatus in accordance with the present subject matter;

FIG. 18 is a front view illustrating another embodiment of a window covering apparatus in accordance with the present subject matter;

FIG. 19A is a top view illustrating one embodiment of a insulating members for a window covering apparatus in accordance with the present subject matter;

FIG. 19B is a front view further illustrating the insulating members of FIG. 19A in accordance with the present subject matter;

FIG. 20A is a partial cross-sectional side view of a motorized support member in accordance with the present subject matter;

FIG. 20B is a partial cross-sectional top view of a motorized support member in accordance with the present subject matter;

FIG. 21 is a perspective view illustrating one embodiment of a window covering apparatus in accordance with the present subject matter;

FIG. 22 is a perspective view illustrating one embodiment of a window covering apparatus in accordance with the present subject matter; and

FIG. 23 is a schematic flow chart diagram illustrating one embodiment of a method in accordance with the present subject matter;

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

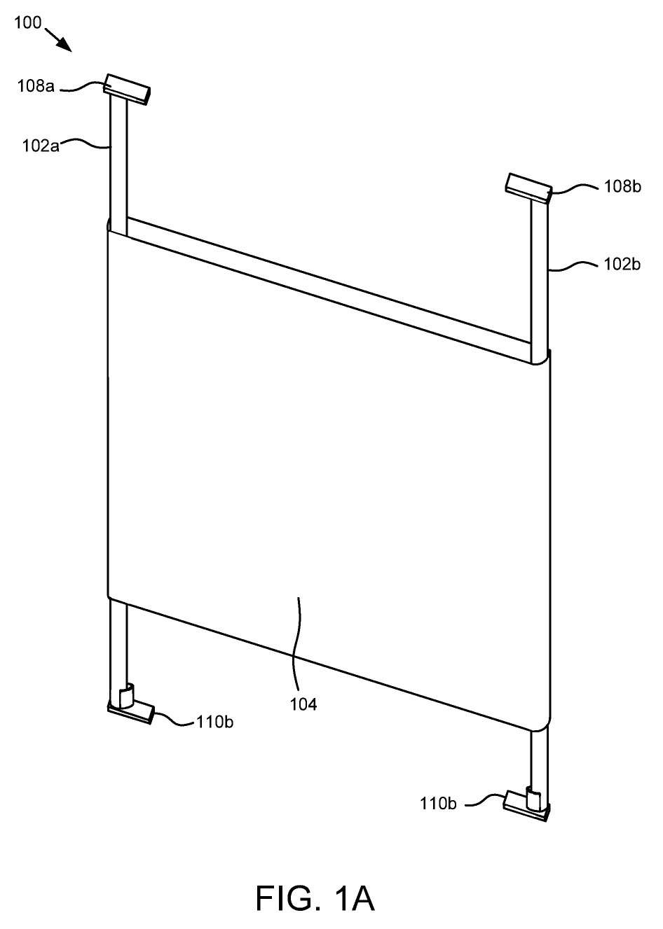

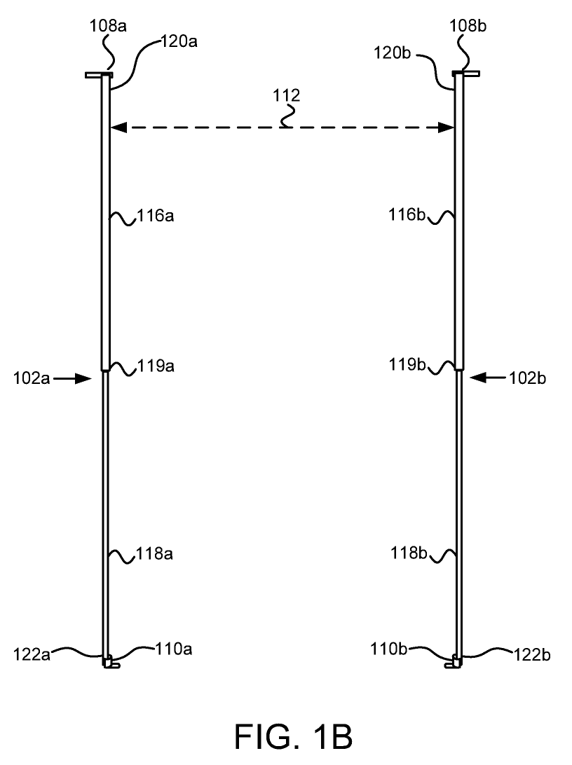

FIG. 1A depicts one embodiment of a window covering apparatus 100. The apparatus 100 includes a first support member 102a and a second support member 102b. In the depicted embodiment, the second support member 102b is spaced apart 114 from the first support member 102a and substantially parallel to the first support member 102a. The apparatus 100 also includes a fabric 104 extending between the first support member 102a and the second support member 102b. In the depicted embodiment, the fabric 104 is movably coupled to the first and second support members 102a, 102b. In addition, the fabric 104 forms a continuous loop through which the first and second support members 102a, 102b extend. The apparatus 100 also includes first anchored bracket 110a, a second anchored bracket 110b, a first anchor mechanism 108a, and a second anchor mechanism 108b as described below. The first and second anchored mechanisms 108a, 108b may couple the first support member 102a and the second support member 102b respectively to a window frame, a wall, a ceiling, or the like. Furthermore, the first and second anchored brackets 110a, 110b secure and prevent movement of the respective support members 102a, 102b as described below. In the depicted embodiment, the first and second support members 102a, 102b are releasably coupled to or retained by the first and second anchored brackets 110a, 110b, respectively, to facilitate convenient removal of the fabric 104 from the support members as will be described in more detail below.

FIG. 1B depicts one embodiment of the first support member 102a and the second support member 102b of the window covering apparatus 100 of FIG. 1. The depicted embodiment also includes a first anchored bracket 110a, a second anchored bracket 110b, a first anchor mechanism 108a, and a second anchor mechanism 108b. In the depicted embodiment, the second support member 102b is spaced apart 112 from the first support member 102a and substantially parallel to the first support member 102a. In one embodiment, the first and second support members 102a, 102b are tubular vertical poles made from any of various materials, such as metal, plastic, wood, and the like.

In one embodiment, the first and second support members 102a, 102b are adjustable elongate elements. For example, each of the first and second support members 102a, 102b may be telescoping poles. Specifically, the first support member 102a may include a receiving section 116a and a received section 118a. The relative positions of the receiving and received sections 116a, 118a are adjustable to adjust a length of the first support member 102a as the received section 118a slides in and out of the receiving section 116a. Similarly, the second support member 102b may include a receiving section 116b and a received section 118b to adjust a length of the second support member 102b. Each receiving section 116a, 116b includes a respective receiving section portion 119a, 119b. In one embodiment, a surface of each receiving section portion 119a, 119b is tapered or beveled so that fabric may slide or move from the respective received section 118a, 118b to the respective receiving section 116a, 116b over the respective receiving section portion 119a, 119b without snagging or bunching. In the depicted embodiment, each support member 102a, 102b includes two sections (e.g. a receiving section 116a, 116b and a received section 118a, 118b), however, in other embodiments, each support member 102a, 102b includes any suitable number of sections to allow telescoping. In another embodiment, each support member 102a, 102b is embodied as a single section and does not telescope.

Each support member 102a, 102b may be coupled to an anchor mechanism 108. In one embodiment, each support member 102a, 102b is coupled to a respective anchor mechanism 108a, 108b near a respective first end 120a, 120b of each support member 102a, 102b (e.g. each receiving section 116a, 116b is coupled to a respective anchored mechanism 108a, 108b). For example, each support member 102a, 102b may be welded, bolted, screwed and/or the like to the respective anchor mechanism 108a, 108b.

The anchor mechanisms 108a, 108b may attach the respective support members 102a, 102b to a surface such as a wall, a window frame, the ceiling, and the like. For example, each anchor mechanism 108a, 108b may include an extending member from each respective support member 102a, 102b, which attaches to the surface with screws, bolts, and/or any suitable attachment mechanism. In one embodiment, each anchored mechanism 108a, 108b attaches to the surface with a removable attachment mechanism, such as a suction cup. For example, the surface may be a car window and each anchor mechanism 108a, 108b attaches to the car window with a suction cup.

Each support member 102a, 102b may be received by a respective anchored bracket 110a, 110b on a respective second end 122a, 122b of the respective support member 102a, 102b opposite the respective first end 120a, 120b (in which the support members 102a, 102b are coupled to the anchor mechanisms 108a, 108b respectively). The anchored brackets 110a, 110b may secure and prevent movement of the respective support members 102a, 102b. Each support member 102a, 102b (e.g. each received section 118a, 118b in the depicted embodiment) may be removably fastened, secured, and/or releasably coupled to the respective anchored bracket 110a, 110b as described below.

The anchored brackets 110a, 110b may secure each support member 102a, 102b to a surface such as a wall, a window frame, a floor, a window sill, the ceiling, and the like. Each anchored bracket 110a, 110b may attach to the surface with screws, bolts, and/or any suitable attachment method. In one embodiment, each anchored bracket 110a, 110b attaches to the surface with a removable attachment such as a suction cup. For example, the surface may be a car window and each anchored bracket 110a, 110b attaches to the car window with a suction cup.

In the depicted embodiment, the first and second support members 102a, 102b may be released from the respective anchored brackets 110a, 110b to allow fabric to be loaded and unloaded onto the first and second support members 102a, 102b. While the first and second support members 102a, 102b are released from the respective anchored brackets 110a, 110b, the first and second support members 102a, 102b may remain anchored to the surface to which the respective anchor mechanisms 108a, 108b are coupled, thereby keeping the first and second support members 102a, 102b from completely disconnecting from the surface. Although in the depicted embodiment, the first and second receiving sections 116a, 116b are coupled to the respective first and second anchor mechanisms 108a, 108b and the first and second received sections 118a, 118b are secured by the first and second anchored brackets 110a, 110b respectively, various combinations of anchor mechanisms 108a, 108b and anchored brackets 110a, 110b may be used. For example a support member 102a may be attached to a surface by way of an anchor mechanism 108a on each end, an anchored bracket 110a on each end, and the like.

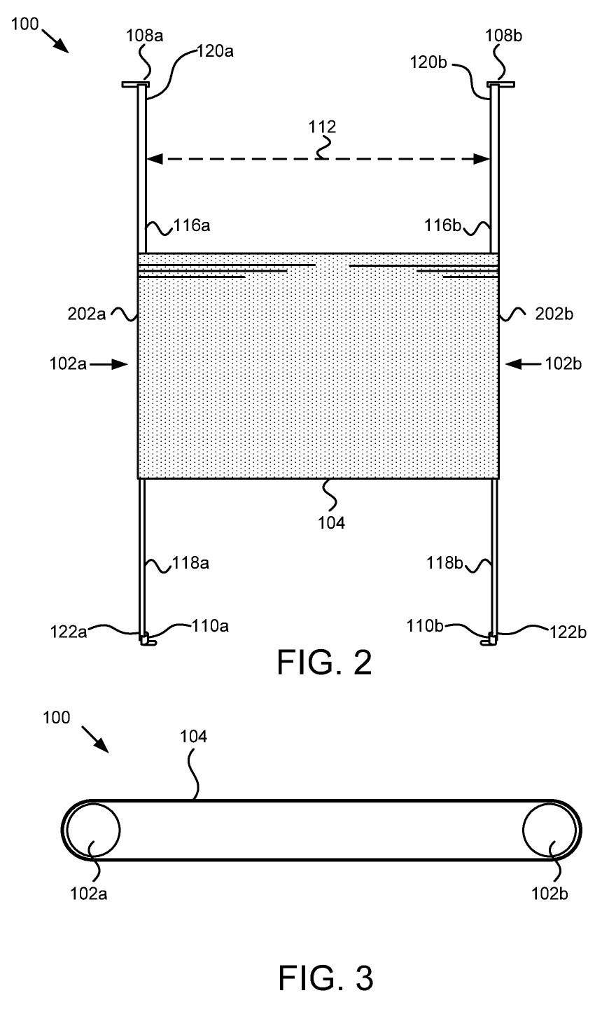

FIG. 2 depicts the apparatus 100 of FIG. 1A with fabric 104 extending between the first support member 102a and the second support member 102b of FIG. 1B. The fabric 104 may be movably coupled to the first support member 102a and the second support member 102b. In one embodiment, a first end 202a of the fabric 104 is movably coupled to the first support member 102a and a second end 202b of the fabric 104 is movably coupled to the second support member 102b. The fabric 104 may be adjacent to at least a portion of each support member 102a, 102b along a length of each support member 102a, 102b.

Referring to FIG. 3, which is a top view 300 of the apparatus 100 of FIG. 1, the fabric 104, in some embodiments, may form a continuous loop through which the first support member 102a and the second support member 102b extend. The continuous loop may extend around (e.g., wrap around) the first and second support members 102a, 102b. In one embodiment, the continuous loop of fabric 104 is formed by one end of a sheet of fabric 104 being stitched to another end of the sheet of fabric 104 to form a continuous loop. In another embodiment, the fabric 104 is manufactured as a continuous loop.

The fabric 104 may be made from an elastic material. The fabric 104 may be a decorator fabric, window treatment fabric, scrim fabric and/or any suitable fabric 104. The fabric 104 may be opaque, substantially opaque, translucent, or the like. In addition, a width that the first support member 102a and the second support member 102b are spaced apart may be adjustable based on a size of the fabric (e.g. the size of the loop). As a result, the first and second support members 102a, 102b may be used in windows and other locations having various widths by changing the size of the fabric 104.

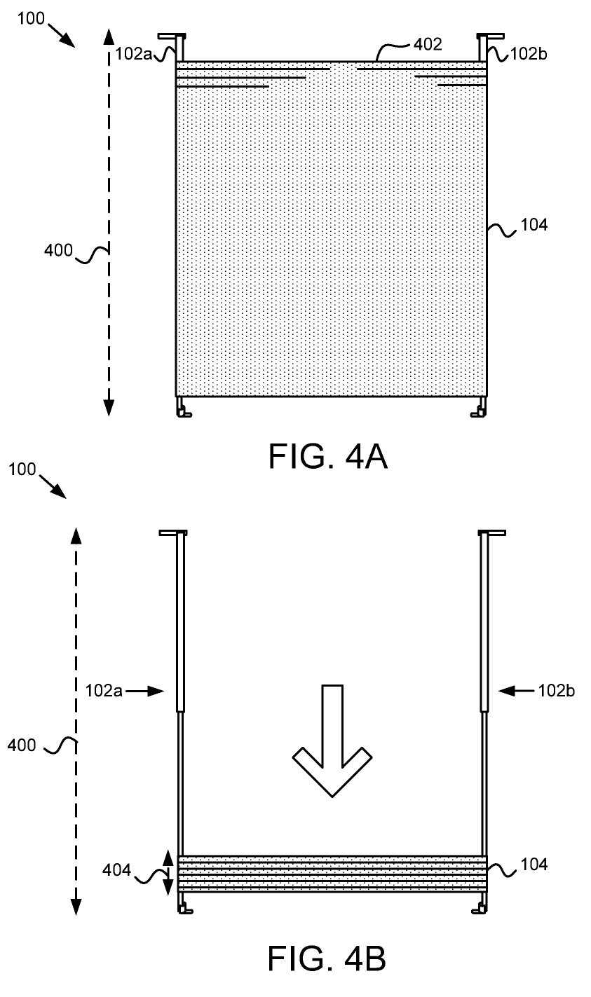

FIG. 4A depicts the apparatus 100 of FIG. 1A in which the fabric 104 extends along substantially a first length 400 of the first and second support members 102a, 102b. The apparatus 100, in other embodiments, includes multiple sheets of fabric 104 extending across various portions of the first and second support members 102a, 102b. As depicted in FIG. 4B, the fabric 104 may be movable to slide along the first support member 102a and the second support member 102b. The fabric 104 may compress such that the fabric 104 extends along a second length 404 of the first and second support members 102a, 102b that is shorter than the first length 400. The fabric 104 may fold and/or bunch as it is compressed to the second length 404. In one embodiment, the fabric 104 moves as a whole and does not bunch or compress such that the fabric 104 extends along a consistent length of the first and second support members 102a, 102b.

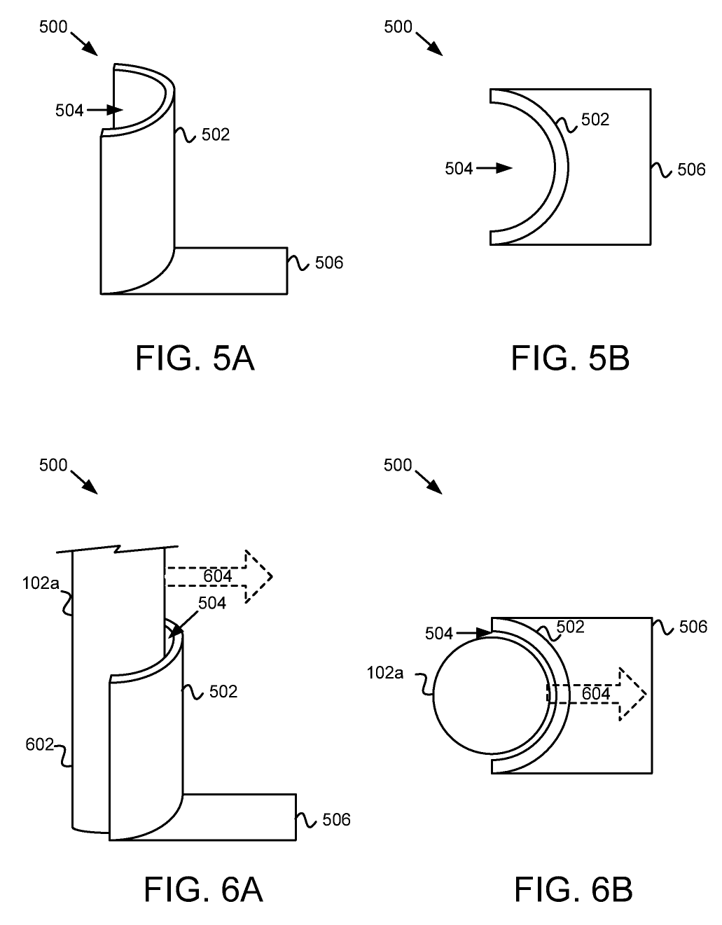

FIG. 5A depicts one embodiment of an anchored bracket 500. The anchored bracket 500 may be the anchored bracket 110a or the anchored bracket 110b of FIGS. 1A-2. The anchored bracket 500 comprises an upright member 502 defining a channel 504. The upright member 502 is coupled to a base 506. Referring also to FIG. 5B, which shows a top view of the anchored bracket 500 of FIG. 5A, in one embodiment, the upright member 502 has a substantially semi-circular shape. The base 506 may be configured to attach to a surface, such as a window frame, window sill, floor, ceiling, and the like. For example, in one embodiment, the base 506 includes one or more screw holes through which one or more screws may be inserted to attach the base to the surface. In the depicted embodiment, the upright member 502 is perpendicular to the base 506, which is suitable to secure a support member 102 to a perpendicular surface. In other embodiments, the upright member 502 and the base 506 may have other configurations to accommodate surfaces parallel to a support member. For example, the upright member 502, in certain embodiments, may be coupled parallel to the base 506.

Referring to FIG. 6A and FIG. 6B, the upright member may receive an end 602 of the support member 102a such that the support member 102a is nestably engaged in the channel 504 of the upright member 502. Furthermore, in one embodiment, the channel 504 corresponds substantially with the shape of the upright member 102a. In one embodiment, the anchored bracket 500 prevents movement of a particular support member 102a in a direction 604 towards the opposing support member. Furthermore, the particular support member 102a may be secured against the anchored bracket 500 by tension in the fabric. In other words, due to the tension in the fabric, referring also to FIG. 2, the opposing support members 102a, 102b are drawn toward each other with the anchored brackets 110a, 110b resisting the inward bias of the support members. As stated above, the fabric 104 may comprise an elastic material that may provide tension that pulls against the particular support member 102a in the direction of the upright member 500.

In the depicted embodiment, the upright member 502 is substantially semi-circular in shape, however, in other embodiments, the upright member may be any suitable shape to secure the particular support member 102a against the anchored bracket 500 with the tension in the fabric. For example, the upright member 502, when viewing from a top view, may be substantially semi-rectangular, may form a “v” shape, may be circular, or the like. In a preferred embodiment, the support member receiving area of the upright member 502, when viewed from a top view, is not flat (e.g., is at least partially concave).

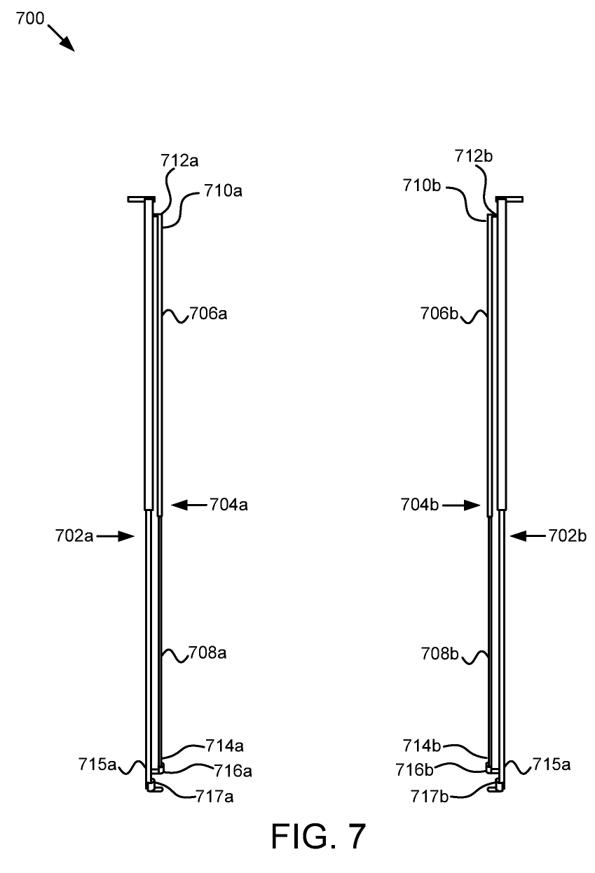

FIG. 7 depicts another embodiment of a window covering apparatus 700 in accordance with the present subject matter. The apparatus 700 includes a first support member 702a and a second support member 702b which may be substantially similar to the first support member 102a and the second support member 102b of FIGS. 1-2. The first and second support members 702a, 702b may be releasably secured to first and second anchored brackets 717a, 717b, respectively, similar to the first and second anchored brackets 110a, 110b described above in relation to FIG. 1. In addition, the apparatus 700 includes a third support member 704a spaced apart from, coupled to, and substantially parallel to the first support member 702a. The apparatus 700 also includes a fourth support member 704b spaced apart from, coupled to, and substantially parallel to the second support member 702a.

Like the first and second support members 702a, 702b, the third and fourth support members 704a, 704b may be adjustable elongate elements. For example, each support member 704a, 704b may be a telescoping pole. Specifically, as described above in relation to the first and second support members 702a, 702b, the third support member 704a may include a receiving section 706a and a received section 708a to adjust a length of the third support member 704a as the received section 708a slides in and out of the receiving section 706a. Similarly, the fourth support member 704b may include a receiving section 706b and a received section 708b to adjust a length of the fourth support member 704b.

The third and fourth support members 704a, 704b may include similar tapering or beveling as the first and second support members 702a, 702b to reduce snagging or bunching of fabric. Furthermore, each of the third and fourth support members 704a, 704b, in the depicted embodiment, respectively includes two sections (e.g. a receiving section 706a, 706b and a received section 708a, 708b), however, in other embodiments, each of the third and fourth support members 704a, 704b includes any suitable number of sections to allow telescoping. In another embodiment, each of the third and fourth support members 704a, 704b is embodied as a single section and does not telescope.

In one embodiment, the third support member 704a is coupled at a first end 712a of the first support member 702a and releasably secured at a second end 715a of the first support member 702a. The third support member 704a may be welded, screwed, or the like at the first end of the first support member 702a. Furthermore, in one embodiment, the third support member 704a is releasably secured to the first support member 702a at the second end 715a of the first support member 702a with a third anchored bracket 716a. The third anchored bracket 716a may attach to the first support member 702a with welding, screws, bolts, and/or the like.

Likewise, in one embodiment, the fourth support member 704b is similarly coupled to a first end 712b of the second support member 702b and releasably secured 712b at a second end 715b of the second support member 704b with a fourth anchored bracket 716b. Furthermore, the third and fourth anchored brackets 716a, 716b may be substantially similar to the first and second anchored brackets 717a, 717b. Specifically, the third anchored bracket 716a may secure and prevent movement of the third support member 704a in relation to the first support member 702a and the fourth anchored bracket 716b may secure and prevent movement of the third support member 704a in relation to the second support member 702b. Also, the third anchored bracket 716a may prevent movement of the third support member 704a in a first direction towards the fourth support member 704b, and the fourth anchored bracket 716b may prevent movement of the fourth support member 704b in a second direction towards the third support member 704a.

In the depicted embodiment, similar to the first and second support members 702a, 702b, the third and fourth support members 704a, 704b may be released from the third and forth anchored brackets 716 to allow fabric to be loaded and unloaded onto the third and fourth support members 704a, 704b. Although in the depicted embodiment, the third and fourth support members 704a, 704b are coupled to the first and second support members 702a, 702b at first ends 712a, 712b of the first and second support members 702a, 702b respectively and releasably secured (with the third and fourth anchored brackets 716a, 716b respectively) to the second ends 715a, 715b of the first and second support members 702a, 702b, respectively, the third and fourth support members 704a, 704b may be releasably secured to the first and second support members 702a, 702b with anchored brackets 716a, 716b respectively, on both ends 712a, 712b, 715a, 715b, on the first end 712a, 712b respectively, or the like, in various combinations.

In one embodiment, the third and fourth support members 704a, 704b and/or third and fourth anchored brackets 716a, 716b are smaller in size (e.g. in length, diameter, and/or the like) in relation to the first and second support members 702a, 702b and first and second anchored brackets 110a, 110b, respectively.

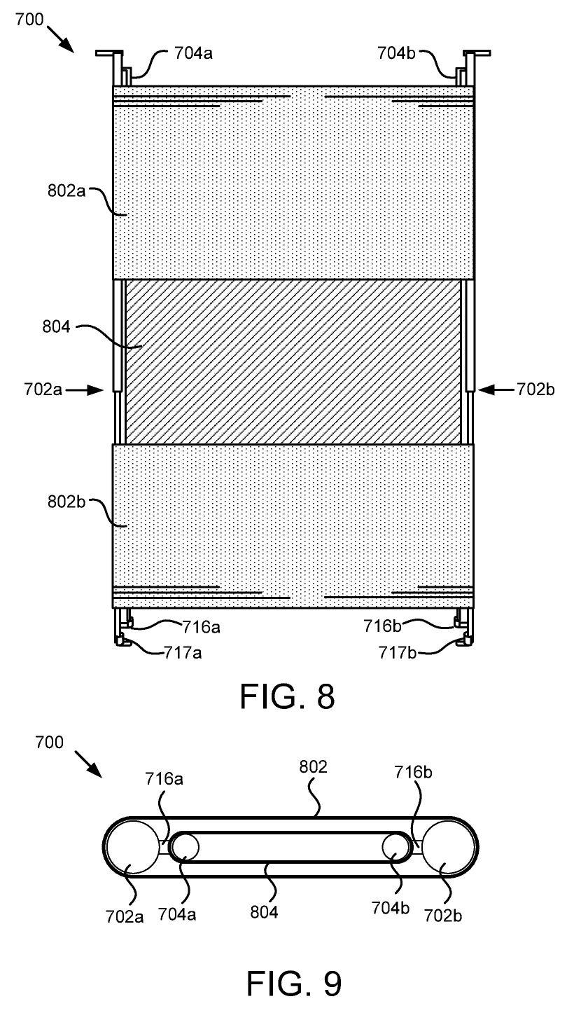

FIG. 8 depicts the apparatus of FIG. 7 with first fabric 802a, 802b (comprising two sheets of first fabric 802a, 802b in the depicted embodiment) extending between the first support member 702a and the second support member 702b and with second fabric 804 extending between the third support member 704a and the fourth support member 704b. The first fabric 802 may be movably coupled to the first support member 702a and the second support member 702b as described above in relation to the apparatus 100 of FIG. 2. Furthermore, the second fabric 804 may also be movably coupled to the third support member 704a and the fourth support member 704b in a similar fashion.

Referring to FIG. 9, which is a top view of the apparatus 700 of FIGS. 7 and 8, the first fabric 802, in some embodiments, may form a first continuous loop through which the first support member 702a and the second support member 702b extend as with the apparatus 100 depicted in FIG. 2. Furthermore, the second fabric 804, in some embodiments, may also form a second continuous loop through which the third support member 704a and the fourth support member 704b extend. The second continuous loop may extend around the third and fourth support members 704a, 704b.

The first fabric 802 and second fabric 804 may be similar to the fabric 104 of FIG. 2 and may comprise an elastic material and include decorator fabric, window treatment fabric, scrim fabric and/or the like. In one embodiment, the first fabric 802 and the second fabric 804 comprise different fabric characteristics. For example, in one embodiment, the first fabric 802 is opaque and the second fabric 804 is translucent. The first fabric 802 may comprise material of a first thickness and the second fabric 804 may comprise material of a second thickness.

Referring back to FIG. 8, the first support member 702a and the second support member 702b may be secured against the first anchored bracket 717a and/or the second anchored bracket 717b, respectively, by tension in the first fabric 802a, 802b and the third support member 704a and/or the fourth support member 704b may be secured against the third anchored bracket 716a and the fourth anchored bracket 716b, respectively, by tension in the second fabric 804. The first fabric 802a, 802b and the second fabric 804 may be movable to slide along the first and second support members 702a, 702b and the third and fourth support members 704a, 704b respectively as with the fabric 104 described in relation to FIG. 4B. As a result, a user may achieve various combinations of window covering using the first fabric 802a, 802b and the second fabric 804. For example, the user may slide the first fabric 802a, 802b to expose the second fabric 804 and to allow a greater amount of light into a room. In one embodiment, the first fabric 802a, 802b includes slits and/or openings, to expose the second fabric 804 without sliding and compressing the first fabric 802a, 802b. In one embodiment, the slits and/or openings include zippers or other fastening structures to maintain the slits and/or openings in a closed position if desired. In certain embodiments, the second fabric 804 may also include similar slits or openings.

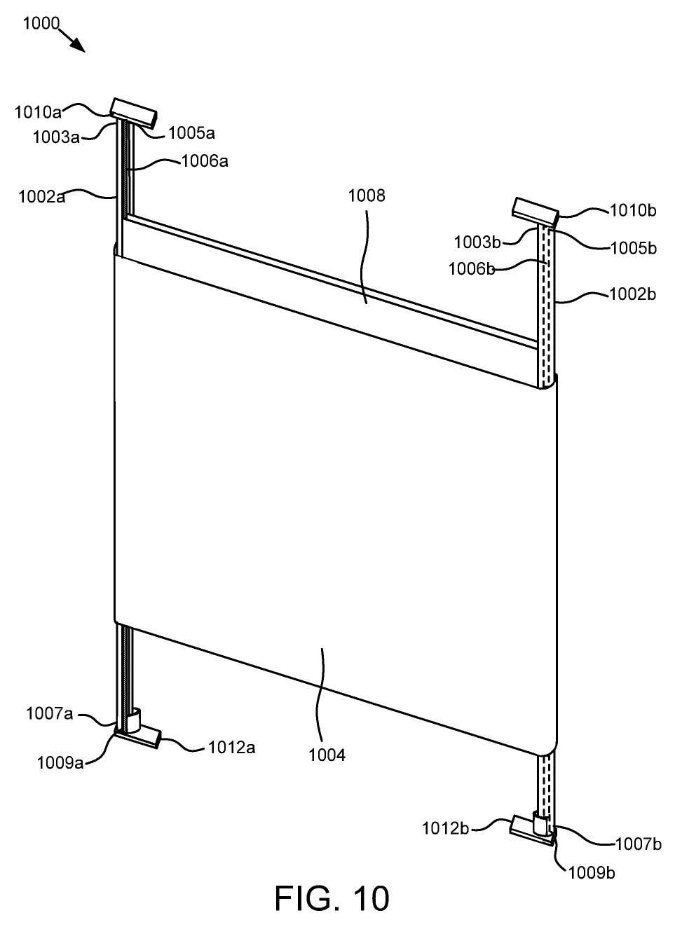

FIG. 10 depicts yet another embodiment of a window covering apparatus 1000. The apparatus 1000 includes a first support member 1002a and a second support member 1002b, referred to as outer support members as described below. As with the apparatus 100 depicted in FIGS. 1A-B and in FIGS. 7-9, in the depicted embodiment, the second support member 1002b is spaced apart from the first support member 1002a and substantially parallel to the first support member 1002a and the apparatus 1000 also includes a first fabric 1004 extending between the first and second support members 1002a, 1002b. Similar to the apparatus 100 described above, in the depicted embodiment, the fabric is movably coupled to the first and second support members 1002a, 1002b. The apparatus 100 also includes a first anchored bracket 110a, a second anchored bracket 110b, a first anchor mechanism 108a, and a second anchor mechanism 108b as described below.

Like the apparatus of FIGS. 7-9, the apparatus 700 includes a third support member 1006a and a fourth support member 1006b with a second fabric 1008 extending between the third support member 1006a and the fourth support member 1006b. The second fabric 1008 is movably coupled to the third and fourth support members 1006a, 1006b.

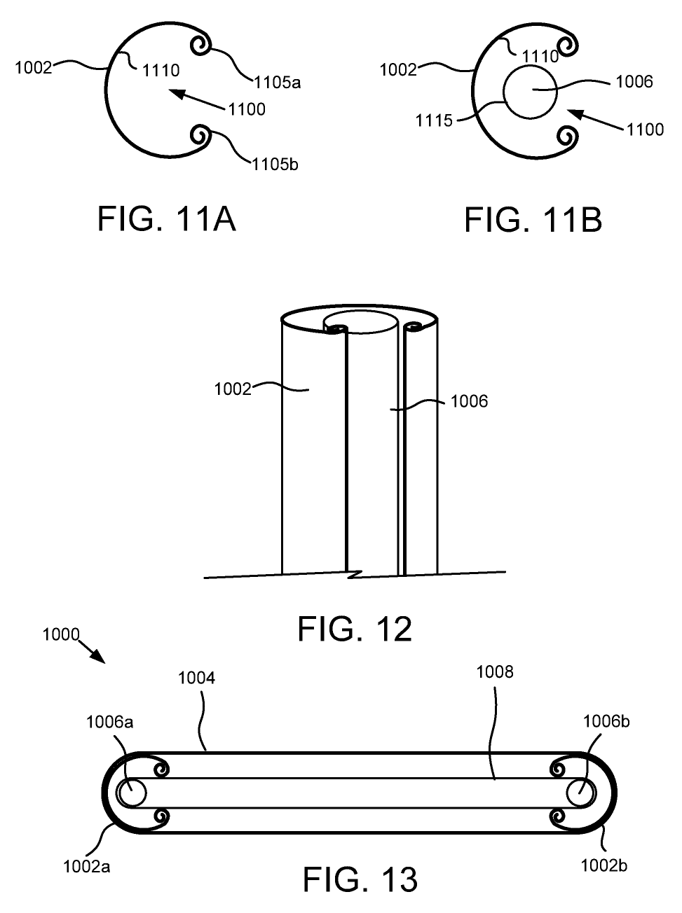

The third and fourth support members 1006a, 1006b are substantially parallel to the first and second support members 1002a, 1002b respectively. In the depicted embodiment, the third and fourth support members 1006a, 1006b are inner support members. Specifically, referring to FIG. 11A, an outer support member 1002 (e.g. the first support member 1002a or the second support member 1002b), defines an interior space 1100. In the depicted embodiment, an inner surface 1110 of the outer support member 1002 defines a curved arc. In the depicted embodiment, the outer support member 1002 includes a first edge portion 1105a and a second edge portion 1105b. The first and second edge portions 1105a, 1105b are curled to prevent the first or second fabric from snagging on the edges of the outer support member 1002.

Referring to FIGS. 11B and 12, an inner support member 1006 (e.g. the third or fourth support members 1006a, 1006b) is positioned within the interior space 1100 of the outer support member 1002. In the context of the embodiment shown in FIG. 10, the first support member 1002a defines a first interior space within the first support member 1002a and the third support member 1006a lies within the first interior space. The second support member 1002b defines a second interior space within the second support member 1002b and the fourth support member 1006b lies within the second interior space.

Except for being within the first and second support members 1002a, 1002b respectively, the third and fourth support members 1006a, 1006b may be similar to the third and fourth support members 708a, 708b as described above in relation to FIGS. 7-9. For example, the third and fourth support members 1006a, 1006b, in one embodiment, are tubular vertical poles made from any of various materials, such as metal, plastic, wood, and the like. Furthermore, the third and fourth support members 1006a, 1006b may be adjustable elongate elements or embodied as single sections as described above in relation to the support members of FIGS. 1A-B, FIG. 7, and the like. In one embodiment, the third and fourth support members 1006a, 1006b are smaller in size (e.g. diameter, and/or the like) in relation to the first and second support members 1002a, 1002b. Unlike certain embodiments of the third and fourth support members 708a, 708b in FIGS. 7-9 above, the third and fourth support members 1006a, 1006b may be substantially the same length as the first and second support members 1002a, 1002b.

The third support member 1006a and the first support member 1002a, in the depicted embodiment, are coupled to a common anchor mechanism 1010a (e.g. a first anchor mechanism). Likewise, in the depicted embodiment, the fourth support member 1006b and the second support member 1002b are coupled to a common anchor mechanism 1010b (e.g. the second anchor mechanism). The first and second anchor mechanisms 1010a, 1010b couple the first and third support members 1002a, 1006a, and the second and third support members 1002b, 1006b respectively to a window frame, a wall, a ceiling, or the like, as described above.

In the depicted embodiment, each support member 1002a, 1002b, 1006a, 1006b is coupled to a respective anchor mechanism 1010a, 1010b near a respective first end 1003a, 1003b, 1005a, 1005b of each support member 1002a, 1002b, 1006a, 1006b. For example, each support member 1002a, 1002b, 1006a, 1006b may be welded, bolted, screwed and/or the like to the respective anchor mechanism 1010a, 1010b. The anchor mechanisms 1010a, 1010b may attach the respective support members 1002a, 1002b, 1006a, 1006b to a surface such as a wall, a window frame, the ceiling, and the like as described above in relation to the first and second support members 102a, 102b in FIGS. 1A and 1B. Although the depicted embodiment shows the outer support member 1002a, 1002b and the inner support member 1006a, 1006b releasably coupled to a common anchor mechanism 1010a, 1010b, in other embodiments, the outer support member 1002a, 1002b and the inner support member 1006a, 1006b are coupled to separate anchor mechanisms.

In the depicted embodiment, the first and third support members 1002a, 1006a are releasably coupled to a common anchored bracket 1012a (e.g. the first anchored bracket). Likewise, in the depicted embodiment, the second support member and the fourth support member 1002b, 1006b are releasably coupled to a common anchored bracket 1012b (e.g. the second anchored bracket). Each support member 1002a, 1002b, 1006a, 1006b is received by a respective anchored bracket 1012a, 1012b on a respective second end 1007a, 1007b, 1009a, 1009b of the respective support member 1002a, 1002b, 1006a, 1006b opposite the respective first ends 1003a, 1003b, 1005a, 1005b (in which the support members 1002a, 1002b, 1006a, 1006b are coupled to the anchor mechanisms 1010a, 1010b respectively). The anchored brackets 1012a, 1012b may secure and prevent movement of the respective support members 1002a, 1002b, 1006a, 1006b. Each support member 1002a, 1002b, 1006a, 1006b may be removably fastened, secured, and/or releasably coupled to the respective anchored bracket 1012a, 1012b as described below. Although the depicted embodiment shows the outer support member 1002a, 1002b and the inner support member 1006a, 1006b releasably coupled to a common anchored bracket 1012a, 1012b, in other embodiments, the outer support member 1002a, 1002b and the inner support member 1006a, 1006b are releasably coupled to separate anchored brackets.

The anchored brackets 1012a, 1012b may secure each support member 1002a, 1002b, 1006a, 1006b to a surface such as a wall, a window frame, a floor, a window sill, the ceiling, and the like as described above in relation to the first and second support members 102a, 102b of FIG. 1A-B.

In the depicted embodiment, the first and second support members 1002a, 1002b and the third and fourth support members 1006a, 1006b are releasable from the respective anchored brackets 1012a, 1012b to allow the first fabric 1004 and the second fabric 1008 to be loaded and unloaded onto the first and second support members 1002a, 1002b and the third and fourth support members 1006a, 1006b respectively as described above. As described above in relation to FIGS. 1A-B, various combinations of anchor mechanisms 1010a, 1010b and anchored brackets 1012a, 1012b may be used. For example a support member 1002a may be attached to a surface by way of an anchor mechanism 1010a on each end, an anchored bracket 1012a on each end, and/or the like.

FIG. 13 further depicts the window covering apparatus 1000 of FIG. 10. The first fabric 1004, in the depicted embodiment, forms a first continuous loop through which the first support member 1002a and the second support member 1002b extend as with the apparatus 100 depicted in FIGS. 1A-B. Furthermore, the second fabric 1008, in the depicted embodiment, forms a second continuous loop through which the third support member 1006a and the fourth support member 1006b extend. The second continuous loop extends around the third and fourth support members 1006a, 1006b. The first fabric 1004 and second fabric 1008 may be similar to the fabrics described above in relation to FIGS. 1A, 1B, and FIGS. 7-9.

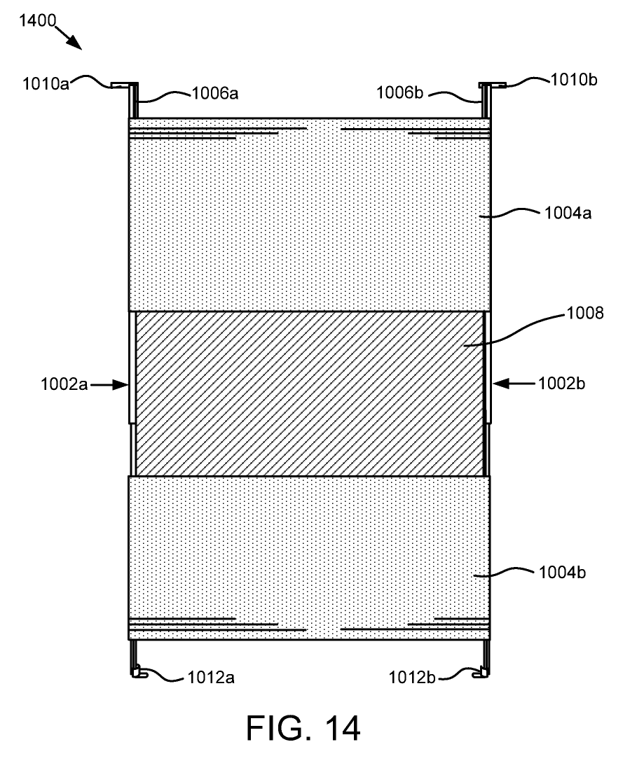

FIG. 14 depicts a window covering apparatus 1400 similar to the window covering apparatus 1000 depicted in FIG. 10 with first and second support members 1002a, 1002b and third and fourth support members 1006a, 1006b similar to those described in relation to FIG. 10. However, the depicted embodiment includes two sheets of first fabric 1004a, 1004b in the depicted embodiment) extending between the first support member 1002a and the second support member 1002b and with second fabric 1008 extending between the third support member 1006a and the fourth support member 1006b. Each of the sheets of first fabric 1004a, 1004b and the second fabric 1008 may be independently slidable along the first and second support members 1002a, 1002b and the third and fourth support members 1006a, 1006b respectively. As described above, any suitable number and type of fabrics may be loaded onto the first and second support members 1002a, 1002b and the third and fourth support members 1006a, 1006b to create various combinations and designs of fabric for various purposes. For example, a user may load a heavier fabric (e.g. that blocks more light) onto the first and second support members 1002a, 1002b and a lighter, more translucent fabric onto the third and fourth support members 1006a, 1006b.

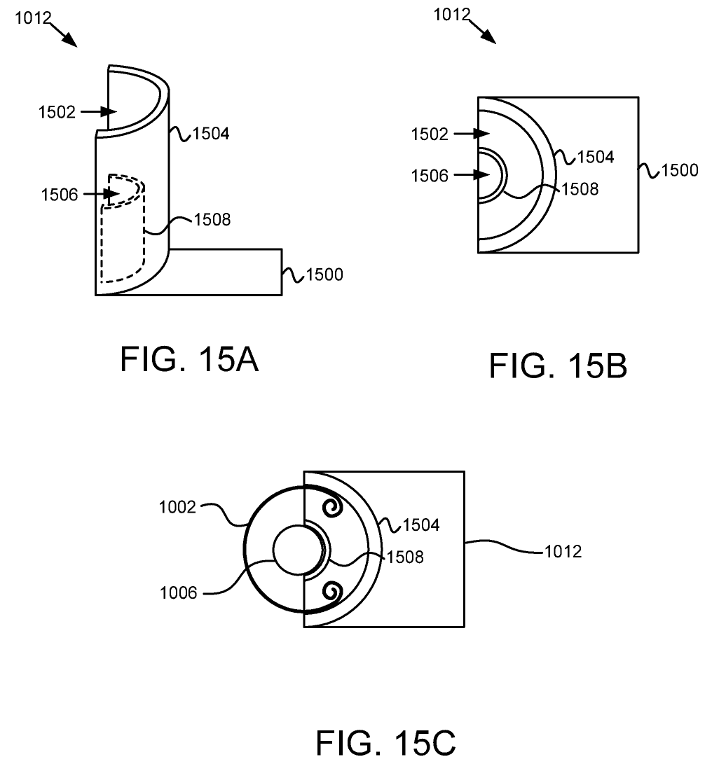

FIG. 15A depicts another embodiment of an anchored bracket 1012. Specifically, the anchored bracket 1012 may be the first anchored bracket 1012a or the second anchored bracket 1012b of FIG. 10. The anchored bracket 1012 comprises a first upright member 1504 defining a first channel 1502. The first upright member 1504 is coupled to a base 1500. The anchored bracket 1012 also comprises a second upright member 1508 defining a second channel 1506. The second upright member 1508 is also coupled to the base 1500.

Referring also to FIG. 15B, which shows a top view of the anchored bracket 1012 of FIG. 15A, in one embodiment, the first and second upright members 1504, 1508 have a substantially semi-circular shape. The base 1500 may be configured to attach to a surface, such as a window frame, window sill, floor, ceiling, and the like as described above in relation to the base 506 of FIGS. 5A-C.

Referring also to FIG. 15C, the first upright member 1504 may receive an end of the outer support member 1002 such that the outer support member 1002 is nestably engaged in the first channel 1502 of the first upright member 1504. In the depicted embodiment, the first channel 1502 corresponds substantially with the shape of the outer support member 1002. The anchored bracket 1012 prevents movement of the outer support member 1002 in a direction towards the opposing support members. The second upright member 1508 may receive an end of the inner support member 1006 such that the inner support member 1006 is nestably engaged in the second channel 1506 of the second upright member 1508. In the depicted embodiment, the second channel 1506 corresponds substantially with the shape of the inner upright member 1006. The anchored bracket 1012 prevents movement of the inner support member 1006 in a direction towards the opposing support members.

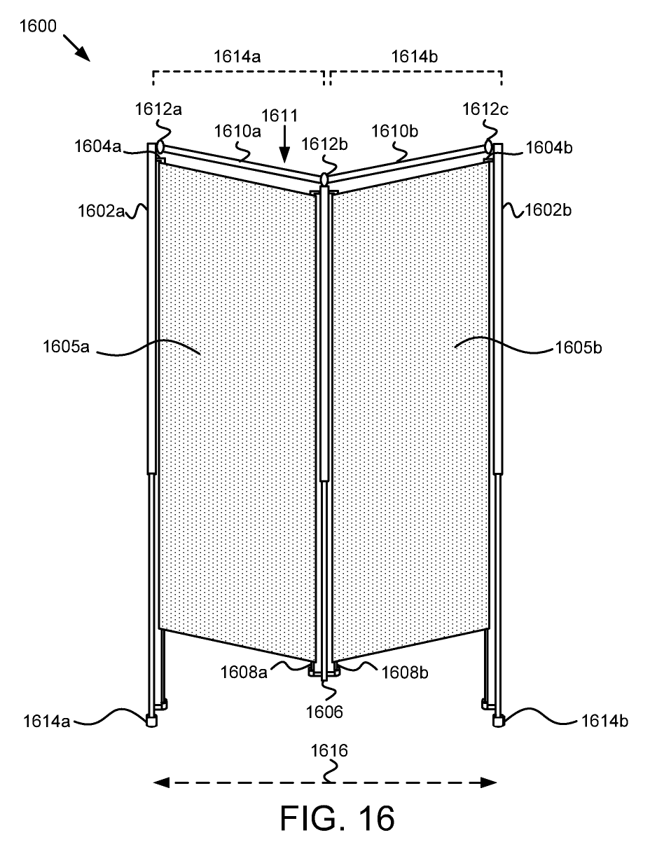

FIG. 16 is a front view illustrating one embodiment of a divider apparatus 1600 in accordance with the present subject matter. The apparatus 1600 includes two fabric assemblies 1614 and includes a first support member 1602a and a second support member 1602b. The first and second support members 1602a, 1602b may be substantially similar to the first and second support members 702a, 702b described above in relation to FIG. 7. Specifically, the apparatus 1600 includes a third support member 1604a spaced apart from the first support member 1602a and substantially parallel to the first support member 1602a and a fourth support member 1604b spaced apart from the second support member 1602b and substantially parallel to the second support member 1602b. The third and fourth support members 1604a, 1604b may be substantially similar to the third and fourth support members 704a, 704b described above in relation to FIG. 7. Furthermore, the third and fourth support members 1604a, 1604b may be coupled, releasably secured, and/or releasably coupled to the first and second support members 1602a, 1602b similar to support members 702a, 702b, 704a, 704b described above in relation to FIG. 7. The first and second support members 1602a, 1602b may each include a base 1614a, 1614b suitable to support the first and second support members 1602a, 1602b. The base 1614a, 164b may include a foot, a wheel, an anchored attachment, or the like.

The apparatus 1614 also includes, between the fabric assemblies 1614a, 1614b, a fifth support member 1606 with sixth and seventh support members 1608a, 1608b, respectively. The fifth, sixth, and seventh support members 1606, 1608a, 1608b may each comprise a telescoping pole, similar to the first, second, third, and fourth 1602a, 1602b, 1604a, 1604bb support members. In one embodiment, the fifth, sixth, and seventh support members 1606, 1608a, 1608b are shorter in length in relation to the first and second support members 1602a, 1602b and the third and fourth support members 1604a, 1604b.

Furthermore, the sixth support member 1608a and the seventh support member 1608b may be similarly coupled and/or releasably secured to the fifth support member 1606 as the third and fourth support members 1604a, 1604b are to the first and second support members 1602a, 1602b respectively. A first fabric 1605a extends between the third support member 1604a and the fifth support member 1606 and a second fabric 1605b extends between the fourth support member 1604b and the sixth support member 1608b. The first and second fabrics 1605a, 1605b may be movably coupled to the respective support members 1604a, 1604b, 1608a, 1608b. In addition, the first and second fabrics 1605a, 1605b may form a continuous loop through which the respective support members 1604a, 1604b, 1608a, 1608b extend as described above.

In one embodiment, the apparatus 1614 includes a frame member 1611 with a first fabric assembly 1610a connecting the first support member 1602a to the fifth support member 1606 and a second fabric assembly 1610b connecting the second support member 1602b to the fifth support member 1606. The frame member 1611 may include a first joint 1612a movably connecting the first fabric assembly 1610a to the first support member 1602a, a second joint 1612b movably connecting the second fabric assembly 1610b with the fifth support member 1606 and the fifth support member 1606 with the second fabric assembly 1610b, and a third joint 1612c movably connecting the second fabric assembly 1610b and the second support member 1602b. Each joint 1612a, 1612b, 1612c may comprise a hinge, a ball and socket joint, or other suitable joint.

The fifth frame member 1611 may allow a width 1616 of the apparatus 1610 to be adjusted. In other embodiments, the apparatus 1614 may have more than two fabric assemblies 1614a, 1614b with additional support members similar to the fifth, sixth, and seventh support members 1606, 1608a, 1608b dividing each fabric assembly 1614a, 1614b.

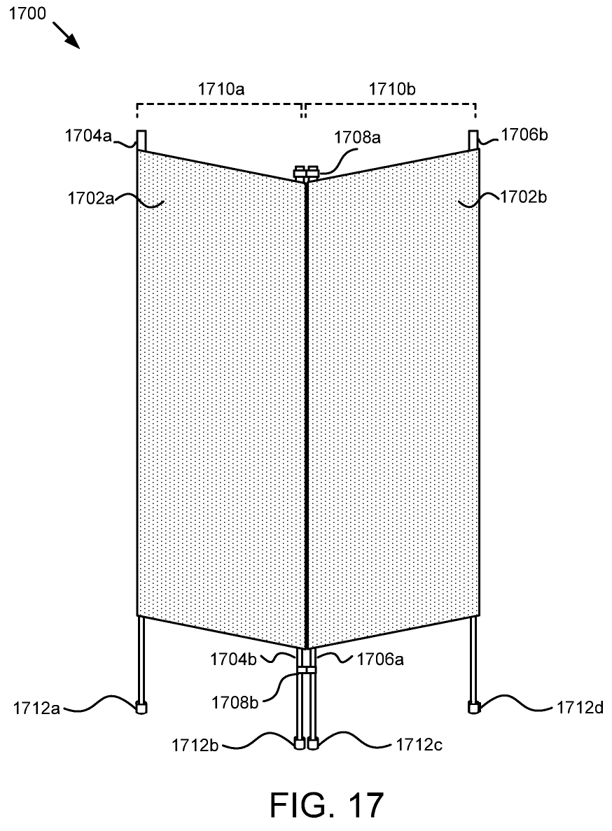

FIG. 17 depicts another embodiment of a divider apparatus 1700. The apparatus 1700 includes a first fabric assembly 1710a and a second fabric assembly 1710b. The first fabric assembly 1710a includes a first support member 1704a and a second support member 1704b. The first fabric assembly 1710a also includes a first fabric 1702a extending between the first support member 1704a and the second support member 1704b. In the depicted embodiment, the first fabric 1702a is movably coupled to the first support member 1704a and the second support member 1704b. In addition, the first fabric 1702a forms a continuous loop through which the first and second support members 1702a, 1702b extend as described above. The first and second support members 1702a, 1702b and the first fabric 1702a may be similar to the first and second support members 102a, 102b and the fabric 104 described above in relation to FIGS. 1A-B.

The apparatus 1700 also includes a second fabric assembly 1710b pivotably coupled to the first fabric assembly 1710a. The second fabric assembly 1710b includes a third support member 1706a and a fourth support member 1706b. The second fabric assembly 1710b also includes a second fabric 1702b extending between the third and fourth support members 1706a, 1706b. The third and fourth support members 1706a, 1706b and the second fabric 1702b may be similar to the first and second support members 1704a, 1704b and first fabric 1702a respectively. The first fabric assembly 1710a and the second fabric assembly 1710b are pivotably coupled in the depicted embodiment with a first joint 1708a and a second joint 1708b, such as a ball and socket joint, a hinge, or other suitable joint. The first fabric assembly 1710a may be positionable in relation to the second fabric assembly 1710b. The first and second support members 1704a, 1704b and the third and fourth support members 1706a, 1706b may each respectively include a base 1712a, 1712b, 1712c, 1712d suitable to support the first and second support members 1704a, 1704b and the third and fourth support members 1706a, 1706b. The base 1712a, 1712b may include a foot, a wheel, an anchored attachment, or the like. Although the depicted embodiment includes a first fabric assembly 1710a and a second fabric assembly 1710b, in other embodiments, the divider apparatus 1700 may include three or more fabric assemblies.

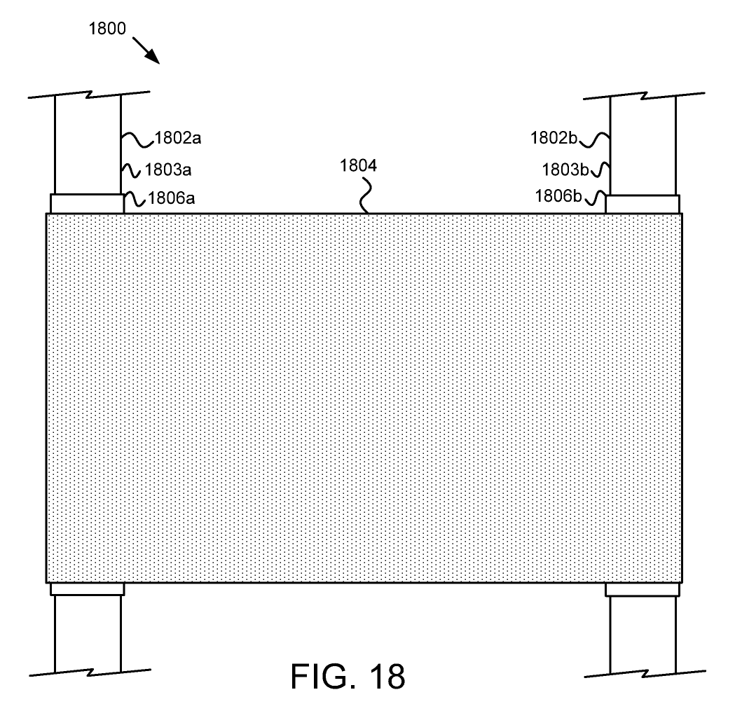

FIG. 18 depicts another embodiment of a window covering apparatus 1800. The apparatus 1800 includes a first support member 1802a and a second support member 1802b with movably coupled fabric 1804 and may be similar to the apparatus 100 of FIGS. 1-2 or the apparatus 700 of FIGS. 7-8. However, in the depicted embodiment, the first support member 1802a includes a first elongate element 1803a (such as a telescopic pole described above) and a first sleeve 1806a movably coupled to the first elongate element 1803a. The second support member 1802b includes a second elongate element 1803b and a second sleeve 1806b movably coupled to the second elongate element 1803b. Each sleeve 1806a, 1806b may include a handle to assist a user in securing the fabric 1804 and sliding the fabric 1804 along the support members 1802a, 1802b. In one embodiment, the fabric 1804 moves as a whole (e.g. without substantially compressing and/or bunching) by way of the first sleeve 1806a and the second sleeve 1806b.

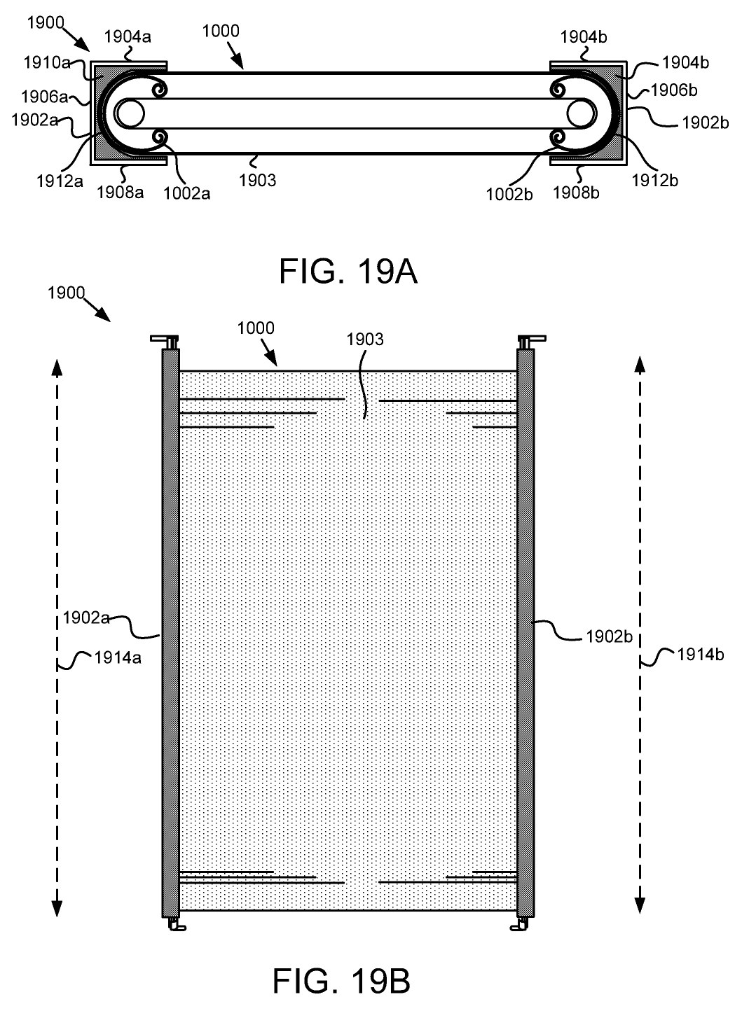

FIG. 19A depicts one embodiment of a first insulating member 1902a and a second insulating member 1902b for a window covering apparatus 1000. The window covering apparatus 1000, in the depicted embodiment, is the window covering apparatus 1000 described above in relation to FIG. 10. However, in other embodiments, the first and second insulating members 1902a, 1902b may be used with the window covering apparatus 100 described above in relation to FIGS. 1A-B or the window covering apparatus 700 described above in relation to FIGS. 7-9. The first insulating member 1902a is positioned about the fabric 1903 in contact with the first support member 1002a adjoining a first end 1912a of the fabric 1903. As described above the first end 1912a of the fabric 1903 is adjacent to the first support member 1002a along a length of the first support member 1002a. The second insulating member 1902b adjoins a second end 1912b of the fabric 1903 and the second end 1912b of the fabric 1903 is adjacent to the second support member 1002b along a length of the second support member 1002b.

In the depicted embodiment, each of the first and second insulating members 1902a, 1902b define a cavity housing an insulating material 1910a. In the depicted embodiment, the insulating material 1910a, 1910b of the first and second insulating members 1902a, 1902b is formed to correspond substantially with the shape of the first and second support members 1002a, 1002b respectively. The insulating material 1910a, 1910b may be felt, padding, or other suitable material sufficient to reduce air flow between the first and second support members 1002a, 1002b and a window frame. Each of the first and second insulating members 1902a, 1902b, in the depicted embodiment, includes a first surface 1904a, 1904b, a second surface 1906a, 1906b, and a third surface 1908a, 1908b defining the cavity. The first, second, and third surfaces 1904a, 1904b, 1906a, 1906b, 1908a, 1908b may comprise metal, plastic, wood, or other suitable material.

FIG. 19B depicts the first and second insulating members 1902a, 1902b of FIG. 19A. In the depicted embodiment, the first and second insulating members 1902a, 1902b are positioned about the fabric 1903 and in contact with the first and second support members 1002a, 1002b respectively along a first length 1914a of the first support member 1002a and a second length 1914b of the second support member 1002b respectively. The first and second insulating members 1902a, 1902b may extend along the respective lengths 1914a, 1914b of the first and second support members 1002a, 1002b to add further insulation to a window and reduce air flow between the first and second support members 1002a, 1002b and the window frame.

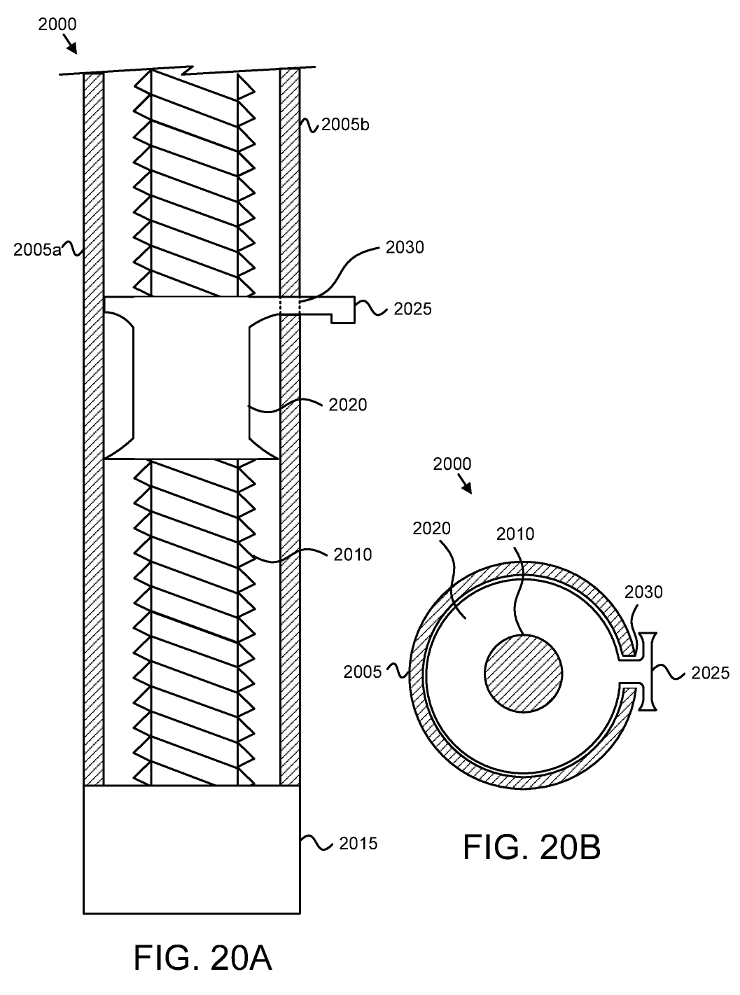

FIG. 20A is a partial cross-sectional side view of a motorized support member 2000. The motorized support member 2000 includes a hollow support member 2005a, 2005b, a threaded rod 2010, a driving mechanism 2015, a carrier mechanism 2020, and a fabric engaging element 2025 extending from an interior (e.g. a slot 2030) in the hollow support member 2005b. The hollow support member 2005a, 2005b may be one embodiment of one or more support members described above in relation to FIGS. 1-12 (e.g. the first and second support members 102a, 102b in FIGS. 1-4B, the first and second support members 702a, 702b or third and fourth support members 704a, 704b in FIG. 7, and the like).

The threaded rod 2010 is positioned within the interior space of the hollow support member and is rotatably driven by the driving mechanism 2015. The driving mechanism 2015 may rotate the threaded rod 2010 in relation to the hollow support member 2005a, 2005b and may comprise a motor such as a stepper motor, an electric motor, and the like, operationally coupled to the threaded rod 2015. The driving mechanism 2015 may also be coupled to the hollow support member 2005a, 2005b. The carrier 2020 may be threaded onto and/or threadably engaged with the threaded rod 2010. The carrier 2020 includes helical threads corresponding to threads on the threaded rod 2010. The carrier 2020 is linearly movable along an interior of the hollow member via rotation of the threaded rod.

The carrier 2020 includes an fabric engaging element 2025 (e.g. an arm) extending from the carrier 2020 through a slot 2030 in the hollow support member 2005a, 2005b. The slot 2030 may extend a length of the hollow support member 2005a, 2005b. The fabric engaging element prevents the carrier 2020 from rotating with the threaded rod 2010. As a result, as the threaded rod 2010 rotates in relation to the hollow support member 2005a, 2005b, the carrier 2020 does not rotate in relation to the hollow support member 2005a, 2005b and the carrier 2020 is driven in a linear motion up or down the threaded rod 2010. FIG. 20B depicts a partial cross-sectional top view of the motorized support member 2000 showing the hollow support member 2005 enclosing the threaded rod 2010, the carrier 2020 threaded onto the threaded rod 2010, and the arm 2025 extending through the slot 2030 in the hollow support member 2005.

Referring also to FIG. 4A, one or more of the first and second support members 102a, 102b may be motorized support members 2000 with fabric engaging element(s) 2025 adjacent and/or coupled to an end 402 of the fabric 202 (e.g. proximate to where the fabric 202 loops around each support member 192a, 102b). Referring also to FIG. 4B, as the carrier 2020 is driven by the driving mechanism 2015, the fabric engaging element 2025 may apply pressure to the fabric 202 and slide the fabric 202 along the first support member 102a and the second support member 102b.

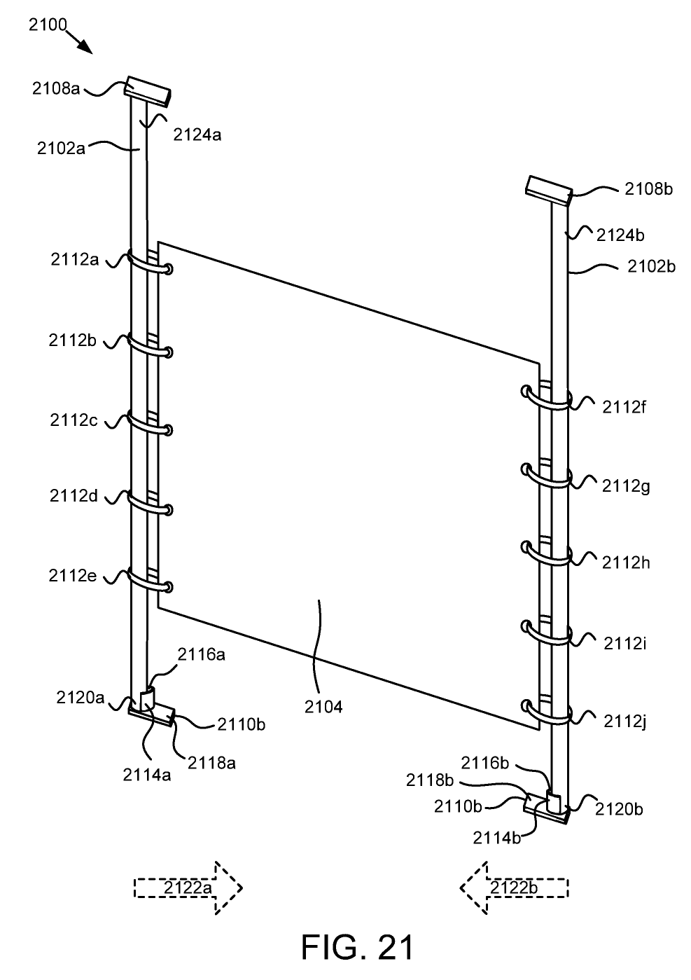

FIG. 21 depicts one embodiment of a window covering apparatus 2100. The apparatus 2100 includes a first support member 2102a and a second support member 2102b. In the depicted embodiment, the first support member 2102a and the second support member 2102b are substantially similar to the first support member 102a and the second support member 102b of apparatus 100 described above. Thus, in one embodiment, the second support member 2102b is spaced apart from the first support member 2102a and substantially parallel to the first support member 2102a. The apparatus 2100 also includes a fabric 2104 extending between the first support member 2102a and the second support member 2102b.

In the depicted embodiment, the fabric 2104 is movably coupled to the first and second support members 2102a, 2102b by a number of clips 2112. Thus, instead of forming a continuous loop with the fabric 2104, in certain embodiments, the fabric 104 is coupled to clips 2112 through which the first and second support members 102a, 102b extend.

The apparatus 2100 also includes a first anchored bracket 2110a, a second anchored bracket 2110b, a first anchor mechanism 2108a, and a second anchor mechanism 2108b as described below. The first and second anchored mechanisms 2108a, 2108b may couple the first support member 2102a and the second support member 2102b respectively to a window frame, a wall, a ceiling, or the like. Furthermore, the first and second anchored brackets 2110a, 2110b secure and prevent movement of the respective support members 2102a, 2102b as described below. In the depicted embodiment, the first and second support members 2102a, 2102b are releasably coupled to or retained by the first and second anchored brackets 2110a, 2110b, respectively, to facilitate convenient removal of the fabric 2104 from the support members. In other embodiments, the clips 2112 are releasably positioned around the first support member 2102a and the second support member 2102b to facilitate convenient removal of the fabric 2104 from the first support member 2102a and the second support member 2102b.

In certain embodiments, the first anchored bracket 2110a and the second anchored bracket 2110b are constructed and operate in a manner substantially similar to the manner in which the anchored bracket 500 of FIGS. 5A-5C are constructed and operate. Thus, in one embodiment, the anchored brackets 2110a and 2110b include an upright member 2114a and 2114b, with each upright member 2114a and 2114b defining a channel 2116a and 2116b respectively. The upright members 2114a and 2114b are coupled to a base 2118a and 2118b respectively. The bases 2118a and 2118b are configured to attach to a surface, such as a window frame, window sill, floor, ceiling, and the like. For example, in one embodiment, the bases 2118a and 2118b include one or more screw holes through which one or more screws may be inserted to attach the bases 2118a and 2118b to the surface. In the depicted embodiment, the upright members 2114a and 2114b are perpendicular to the bases 2118a and 2118b, which is suitable to secure the support members 2110a and 2114b to a perpendicular surface. In other embodiments, the upright members 2114a and 2114b and the bases 2118a and 2118b may have other configurations to accommodate surfaces parallel to a support member.

The upright members 2114a and 2114b receive an first end 2120a and 2120b of the support members 2102a and 2120b such that the support members 2102a and 2120b are nestably engaged in the channels 2116a 2116b of the upright members 2114a and 2114b. Furthermore, in one embodiment, the channels 2116a and 2116b correspond substantially with the shape of the upright members 2102a and 2102b. In one embodiment, the anchored bracket 2110a and 2110b prevent movement of a particular support member 2102a or 2110b in a direction 2122a or 2122b towards the opposing support member. Furthermore, the particular support member 2102a or 2102b may be secured against the anchored bracket 2110a or 2110b by tension in the fabric 2104. In other words, due to the tension in the fabric, the opposing support members 2102a, 2102b are drawn toward each other with the anchored brackets 2110a, 2110b resisting the inward bias of the support members 2102a, 2102b. As stated above, the fabric 2104 may comprise an elastic material that may provide tension that pulls against the particular support member 2102a or 2102b in the direction of the upright member 2114a or 2114b.

A second end 2124a, 2124b of each support member 2102a, 2102b may be coupled to anchor mechanisms 2108a, 2108b respectively. For example, each support member 2102a, 2102b may be welded, bolted, screwed and/or the like to the respective anchor mechanism 2108a, 2108b. The anchor mechanisms 2108a, 2108b attach the respective support members 2102a, 2102b to a surface such as a wall, a window frame, the ceiling, and the like. In one embodiment, each anchor mechanism 2108a, 2108b may include an extending member from each respective support member 2102a, 2102b, which attaches to the surface with screws, bolts, and/or any suitable attachment mechanism. In certain embodiments, each anchored mechanism 2108a, 2108b attaches to the surface with a removable attachment mechanism, such as a suction cup. For example, the surface may be a car window and each anchor mechanism 2108a, 2108b attaches to the car window with a suction cup. The anchor mechanisms 2108a, 2108b resisting the inward bias of the support members 2102a, 2102b to keep the second ends 2124a, 2124b from being drawn inwards towards each other in the directions indicated by arrows 2122a and 2122b.

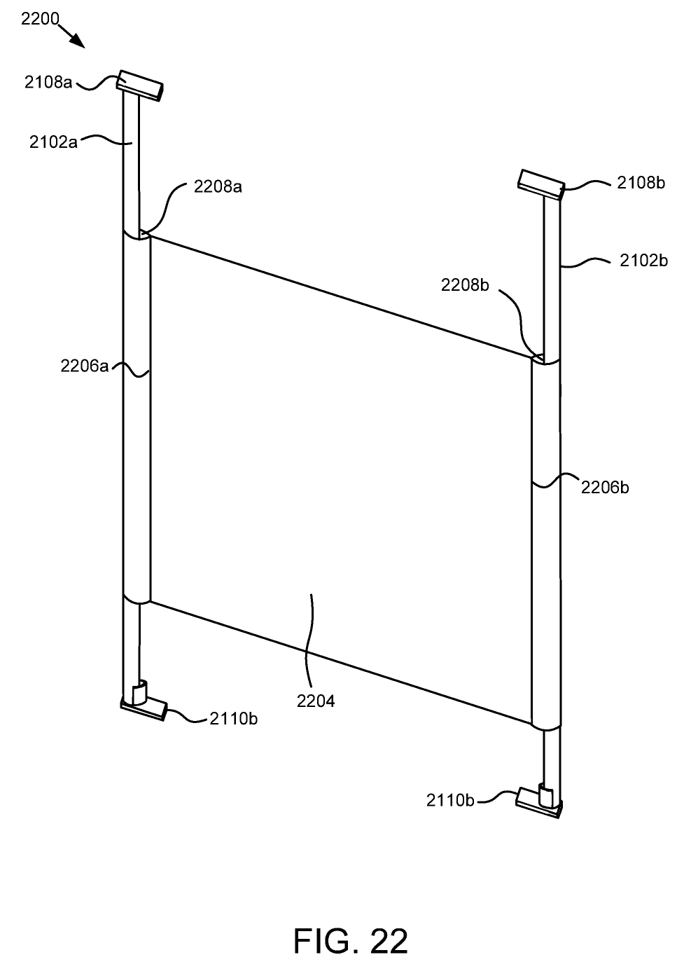

FIG. 22 depicts one embodiment of a window covering apparatus 2200. The apparatus 2200 includes a first support member 2102a, a second support member 2102b, a first anchored bracket 2110a, a second anchored bracket 2110b, a first anchor mechanism 2108a, and a second anchor mechanism 2108b. In the depicted embodiment, the first support member 2102a, the second support member 2102b, the first anchored bracket 2110a, the second anchored bracket 2110b, the first anchor mechanism 2108a, and the second anchor mechanism 2108b are substantially similar to the first support member 2102a, the second support member 2102b, the first anchored bracket 2110a, the second anchored bracket 2110b, the first anchor mechanism 2108a, and the second anchor mechanism 2108b of apparatus 2100 described above.

The apparatus 2200 also includes a fabric 2204 extending between the first support member 2102a and the second support member 2102b. The fabric 2204 may be made from an elastic material. The fabric 2204 may be a decorator fabric, window treatment fabric, scrim fabric and/or any suitable fabric 2204. The fabric 2204 may be opaque, substantially opaque, translucent, or the like. In addition, a width that the first support member 2102a and the second support member 2102b are spaced apart may be adjustable based on a size of the fabric 2204. As a result, the first and second support members 2102a, 2102b may be used in windows and other locations having various widths by changing the size of the fabric 2204.

In certain embodiments, each end 2206a, 2206b of the fabric 2204 is doubled back onto the fabric 2204 and coupled to the fabric 2204 to form loops 2208a and 2208b. The loops 2208a, 2208b are sized to slideably receive the first support member 2102a and the second support member 2102b. Thus, the fabric 2204 is movably coupled to the first support member 2102a and the second support member 2102b by receiving the first support member 2102a and the second support member 2102b within loops 2208a, 2208b.

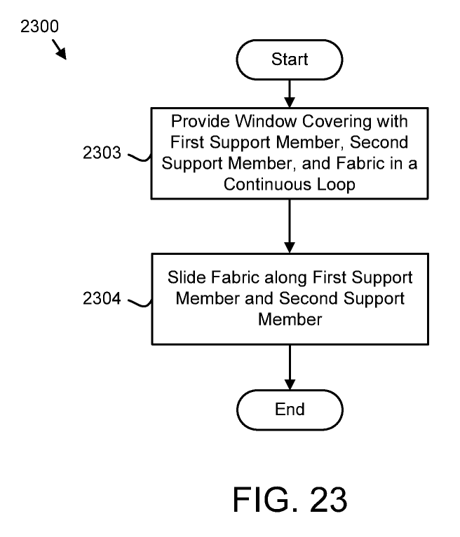

FIG. 23 depicts one embodiment of a method 2300 in accordance with the present subject matter. The method 2300 may comprise a method of using embodiments of the window covering apparatus 100, 700, 1000, 1600, 1700, 2100, 2200 described above. The method 2300 includes providing 2302 a window covering. The window covering may be substantially similar to the window covering apparatus 100 described above in relation to FIGS. 1A-6B, the window covering apparatus 700 of FIGS. 7-10, the window covering apparatus 1000 of FIGS. 10, 13, and 15, the apparatus of FIG. 16 or FIG. 17, the window covering apparatus 2100 described above in relation to FIG. 21, or the window covering apparatus 2200 described above in relation to FIG. 22. Specifically, the window covering apparatus may include a first support member, a second support member, and fabric extending between the first support member and the second support member.

The method 2300 then includes sliding 2304 the fabric along the first support member and the second support member. In one embodiment, an operator may grasp the fabric directly on the first side and the second side or by grasping a handle coupled to the fabric, or handle couple to a sleeve and slide the fabric. In another embodiment, an operator may operate a driving mechanism coupled to the first support member and or second support member. The driving mechanism may drive a threaded rod to linearly move a carrier and a fabric engaging element to slide the fabric as described above. Then, the method 2300 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a first support member;
a second support member spaced apart from the first support member and substantially parallel to the first support member; and
a fabric extending between the first support member and the second support member, the fabric movably coupled to the first support member and the second support member, the fabric forming a continuous loop through which the first support member and the second support member extend.

2. The apparatus of claim 1, further comprising:
a first anchored bracket configured to receive and prevent movement of the first support member in a first direction towards the second support member; and
a second anchored bracket configured to receive and prevent movement of the second support member in a second direction towards the first support member.

3. The apparatus of claim 2, wherein one or more of the first support member and the second support member are secured against the first anchored bracket and the second anchored bracket, respectively, by tension in the fabric.

4. The apparatus of claim 1, further comprising:
a third support member positioned substantially parallel to the first support member; and
a fourth support member positioned substantially parallel to the second support member.

5. The apparatus of claim 4, wherein the third support member is spaced apart from the first support member and the fourth support member is spaced apart from the second support member.

6. The apparatus of claim 5, wherein the third support member is coupled to a first end of the first support member and releasably coupled to a second end of the first support member and wherein the fourth support member is coupled to a first end of the second support member and releasably coupled to a second end of the second support member.

7. The apparatus of claim 4, wherein the first support member defines a first interior space within the first support member and the third support member lies within the first interior space and wherein the second support member defines a second interior space within the second support member and the fourth support member lies within the second interior space.

8. The apparatus of claim 4, wherein the fabric is a first fabric, the apparatus further comprising a second fabric extending between the third support member and the fourth support member, the second fabric movably coupled to the third support member and the fourth support member.

9. The apparatus of claim 8, wherein the continuous loop is a first continuous loop and wherein the second fabric forms a second continuous loop through which the third support member and the fourth support member extend, the second continuous loop being within the first continuous loop.

10. The apparatus of claim 4, further comprising:
a third anchored bracket coupled to the first support member, the third anchored bracket configured to receive and prevent movement of the third support member in the first direction towards the fourth support member; and
a fourth anchored bracket coupled to the second support member, the fourth anchored bracket configured to receive and prevent movement of the fourth support member in the second direction towards the third support member.

11. The apparatus of claim 1, wherein the first support member comprises a first elongate element and a first sleeve movably coupled to the first elongate element, and the second support member comprises a second elongate element and a second sleeve movably coupled to the second elongate element, wherein the fabric is wrapped around the first sleeve and the second sleeve, the first sleeve and the second sleeve being slidable along the first elongate element and the second elongate elements respectively.

12. The apparatus of claim 1, wherein the first support member defines an interior space, the apparatus further comprising:
a driving mechanism coupled to the first support member;
a threaded rod rotatably driven by the driving mechanism, the threaded rod positioned within the interior space of the first support member;
a carrier threadably engaged with the threaded rod, the carrier being linearly movable along an interior of the first support member via rotation of the threaded rod; and
a fabric engaging element that extends from the interior of the first support member through a slot in the first support member, the fabric engaging element preventing the carrier from co-rotating with the threaded rod, the fabric engaging element operable to slide the fabric along the first support member and the second support member in response to the driving mechanism driving the threaded rod.

13. The apparatus of claim 1, further comprising:
a first insulating member positioned about the fabric in contact with the first support member adjoining a first end of the fabric, the first end adjacent to the first support member along a length of the first support member; and
a second insulating member adjoining a second end of the fabric, the second end adjacent to the second support member along a length of the second support member.

14. The apparatus of claim 1, wherein the first support member, the second support member, and the first fabric comprises a first fabric assembly, the apparatus further comprising a second fabric assembly pivotably coupled to the first fabric assembly.

15. A window covering comprising:
a first elongated support member comprising a first telescoping pole;
a second elongated support member spaced apart from the first elongated support member and substantially parallel to the first elongated support member, the second elongated support member comprising a second telescoping pole; and
an elastic fabric extending between the first elongated support member and the second elongated support member, the fabric movably coupled to the first elongated support member and the second elongated support member, the fabric forming a continuous loop extending around the first elongated support member and the second elongated support member.

16. The window covering of claim 15, further comprising:
a first anchored bracket configured to receive and prevent movement of the first elongated support member in a first direction towards the second elongated support member; and
a second anchored bracket configured to receive and prevent movement of the second elongated support member in a second direction towards the first elongated support member.

17. The window covering of claim 16, wherein one or more of the first elongated support member and the second elongated support member are secured against the first anchored bracket and the second anchored bracket, respectively, by tension in the fabric.

18. The window covering of claim 15, further comprising:
a third elongated support member spaced apart from the first elongated support member and substantially parallel to the first elongated support member; and
a fourth elongated support member spaced apart from the second elongated support member and substantially parallel to the second elongated support member.

19. The window covering of claim 18, wherein the fabric is a first fabric, the window covering further comprising a second fabric extending between the third elongated support member and the fourth elongated support member, the fabric movably coupled to the third elongated support member and the fourth elongated support member.

20. A window covering comprising:
a first elongated support member;
a second elongated support member spaced apart from the first elongated support member and substantially parallel to the first elongated support member; and
an elastic fabric extending between the first elongated support member and the second elongated support member, the fabric movably coupled to the first elongated support member and the second elongated support member.
